(19) United States
(12) Patent Application Publication
(10) Pub. No.: US 2024/0091995 A1
(43) Pub. Date: Mar. 21, 2024

(54) METHODS AND SYSTEMS FOR FORMING MICROCELLULAR BUBBLES IN SELECTED PORTION OF A THERMOPLASTIC MEMBER

(71) Applicant: University of Washington, Seattle, WA (US)

(72) Inventors: Vipin KUMAR, Seattle, WA (US); Rohil Anil MANAKAD, Seatle, WA (US); Mohammad MALAKOOTI, Seattle, WA (US)

(21) Appl. No.: 18/467,255

(22) Filed: Sep. 14, 2023

Related U.S. Application Data
(60) Provisional application No. 63/375,643, filed on Sep. 14, 2022.

(51) Int. Cl. B29C 44/34

(52) U.S. Cl. CPC B29C 44/3415; B29K 2105/041

(57) ABSTRACT

Method and system for forming of microcellular bubbles within a thermoplastic member employ an energy beam to form the microcellular bubbles within a selected portion of the thermoplastic member. A method includes infusing the thermoplastic member with a gas to form a gas-infused thermoplastic member and transmitting an energy beam onto the selected portion of the gas-infused thermoplastic member to induce subsurface heating of the selected portion of the gas-infused thermoplastic member to form microcellular bubbles within the selected portion of the gas-infused thermoplastic member.

### CROSS-REFERENCES TO RELATED APPLICATIONS

This application claims the benefit of U.S. Provisional Application No. 63/375,643 filed Sep. 14, 2022, the entire contents of which are hereby incorporated for all purposes in their entirety.

### BACKGROUND

A microcellular plastic (aka microcellular foam) can be formed to contain microcellular bubbles, which typically have diameters from 0.1 to 100 micrometers. A microcellular plastic can be formed using a two-step process. First, a gas is infused into a plastic. The resulting gas-infused plastic can then be heated to nucleate the bubbles. The microcellular bubbles are often used to reduce material usage while still maintaining desired material properties. The density of the microcellular plastic can be controlled via the infusion gas used and be in a range from 5% to 99% of the density of the base plastic.

### BRIEF SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments described herein are directed to method and system for selective formation of microcellular bubble in a thermoplastic member. In many embodiments, a thermoplastic member is infused with a gas (e.g., CO2) under pressure. Microcellular bubbles are formed in a selected portion of the gas-infused thermoplastic member via an energy beam directed into the selected portion to internally heat the selected portion to induce formation of microcellular bubbles in the selected portion. Selective formation of microcellular bubbles within a selected portion of a thermoplastic member can be used to change physical properties within the selected portion. The approaches disclosed herein can be employed in any suitable application, such as, for example, the formation of a “live hinge” in a thermoplastic sheet, the fabrication of an acoustic barrier, the fabrication of a thermal barrier, and modification of a dielectric constant in a thermoplastic member used in a semiconductor device.

Thus, in one aspect, a method of forming microcellular bubbles within a selected portion of a thermoplastic member is provided. The method includes infusing the thermoplastic member with a gas to form a gas-infused thermoplastic member and transmitting an energy beam onto the selected portion of the gas-infused thermoplastic member to induce subsurface heating of the selected portion of the gas-infused thermoplastic member to form microcellular bubbles within the selected portion of the gas-infused thermoplastic member.

The thermoplastic member can be infused with any suitable gas via any suitable approach to form the gas-infused thermoplastic member. For example, infusing the thermoplastic member with the gas can include applying a pressure to the thermoplastic member that is equal to or greater than 5 MPa. The gas can include carbon dioxide.

Any suitable energy beam can be employed to form the microcellular bubbles within the selected portion of the gas-infused thermoplastic member. For example, the energy beam employed can include electromagnetic radiation comprising wavelengths in a range from 9.4 to 10.6 microns. The energy beam employed can include pulses. In many embodiments, the energy beam includes electromagnetic radiation.

The diameters of the microcellular bubbles can be formed within a specified range. For example, the microcellular bubbles have diameters in a range from one to 100 micrometers.

The microcellular bubbles can be formed to extend throughout a range of depths from an irradiated surface of the gas-infused thermoplastic member onto which the energy beam is transmitted. For example, in some embodiments, the range of depths is in a range from 0.1 mm to 0.6 mm.

The energy beam can be configured to account for attenuation of the energy beam by the gas-infused thermoplastic member. For example, the energy beam can have a converging cross-section to compensate for attenuation of the energy beam during penetration of the energy beam into the gas-infused thermoplastic member. In some embodiments, the energy beam is focused to a subsurface focal point within the gas-infused thermoplastic member. The subsurface focal point can be scanned within the gas-infused thermoplastic member throughout a three-dimensional subsurface volume of the gas-infused thermoplastic member.

The thermoplastic member can have any suitable configuration. For example, the thermoplastic member can be formed from one or more of polycarbonate (PC), Polyetherimide (PEI), Thermoplastic polyurethane (TPU), Polyethylene terephthalate (PET), Polyvinyl chloride (PVC), Acrylonitrile butadiene styrene (ABS), or any other amorphous or semi-crystalline thermoplastic with a glass transition temperature above room temperature. In some embodiments, the thermoplastic member is configured as a thermoplastic sheet with a thickness in a range from 0.5 to 2 mm.

The microcellular bubbles can be used to modify properties of the selected portion of the gas-infused thermoplastic member for use in any suitable application. For example, in some embodiments, the microcellular bubbles can be formed in the selected portion of the gas-infused thermoplastic member to reduce a bending strength of the selected portion to configure the selected portion as a live hinge for use in forming the gas-infused thermoplastic member.

In many embodiments, the gas-infused thermoplastic member includes an unselected portion in which microcellular bubbles are not formed. In some embodiments, the selected portion of the gas-infused thermoplastic member is at least partially surrounded by an unselected portion of the gas-infused thermoplastic member onto which the energy beam is not transmitted.

In another aspect, a system for forming microcellular bubbles within a selected portion of a gas-infused thermoplastic member employs an energy beam. The system includes a support, an energy beam source, and a scanning assembly. The support is configured for holding the gas-infused thermoplastic member. The energy beam source is operable to generate and transmit the energy beam. The scanning assembly is coupled with the support and/or the energy beam source. The scanning assembly is operable to produce controlled relative movement between the support and the energy beam source to scan the energy beam onto and over the selected portion of the gas-infused thermoplastic member to form microcellular bubbles within the selected portion.

The energy beam source can include any suitable components for generating and transmitting the energy beam. For example, the energy beam source can include at least one of: one or more laser diodes that are operable to emit one or more coherent laser beams, one or more filaments that are operable to emit one or more electron beams, or one or more ultrasonic transducers that are operable to emit one or more ultrasonic acoustic beams.

The scanning assembly can have any suitable configuration for scanning the energy beam relative to the gas-infused thermoplastic member. For example, in some embodiments, the scanning assembly translates the energy beam source relative to the gas-infused thermoplastic member. In some embodiments, the scanning assembly includes a focusing mechanism that is operable to focus the energy beam to a subsurface focal point within the gas-infused thermoplastic member.

In many embodiments, the system for forming microcellular bubbles within a selected portion of a gas-infused thermoplastic member includes control unit to control operation of the system. The control unit can, for example, include a processor and a non-transitory computer-readable memory storing instruction executable by the processor to cause the processor to control operation of the scanning assembly and/or the energy beam source.

In many embodiments of the system, the gas-infused thermoplastic member can include an unselected portion in which microcellular bubbles are not formed. For example, in many embodiments of the system, the selected portion of the gas-infused thermoplastic member can be at least partially surrounded by an unselected portion of the gas-infused thermoplastic member onto which the energy beam is not transmitted.

The system can further be configured to infuse the gas into the thermoplastic member to form the gas-infused thermoplastic member. For example, the system can further include a gas infusion assembly to infuse a gas into the thermoplastic member prior to scanning of the energy beam onto and over the selected portion of the gas-infused thermoplastic member to form the microcellular bubbles.

For a fuller understanding of the nature and advantages of the present invention, reference should be made to the ensuing detailed description and accompanying drawings.

### BRIEF DESCRIPTION OF THE DRAWINGS

Various embodiments in accordance with the present disclosure will be described with reference to the drawings, in which:

FIG. 1 is a schematic of an apparatus for forming microcellular bubbles within a selected portion of a thermoplastic member, in accordance with certain aspects of the present disclosure.

FIG. 2 is a simplified block diagram of a system for forming microcellular bubbles within a selected portion of a thermoplastic member, in accordance with certain aspects of the present disclosure.

FIG. 3 is a simplified block diagram of a method of forming microcellular bubbles within a selected portion of a thermoplastic member, in accordance with certain aspects of the present disclosure.

FIG. 4 shows an electron microscope photograph of an example thermoplastic member having microcellular bubbles formed in accordance with certain aspects of the present disclosure.

FIG. 5A shows a photograph of a laser engraver used to direct an energy beam into a gas-infused thermoplastic material to form the microcellular bubbles in the thermoplastic member shown in of FIG. 4.

FIG. 5B is an exemplary graphical user interface for controlling the laser engraver of FIG. 5A.

FIG. 6A is an exemplary graph of laser beam power as a function of scanning speed that illustrates a process window for successful formation of microcellular bubbles within a gas-infused thermoplastic member, in accordance with certain aspects of the present disclosure.

FIG. 6B is another exemplary graph of laser beam power as a function of scanning speed that illustrates a process window for successful formation of microcellular bubbles within a gas-infused thermoplastic member, in accordance with certain aspects of the present disclosure.

FIG. 6C is an exemplary graph of speed vs. power for transmitting an energy beam into a thermoplastic material to form microcellular bubbles, in accordance with certain aspects of the present disclosure.

FIG. 6D is another exemplary graph of speed vs. power for transmitting an energy beam into a thermoplastic material to form microcellular bubbles, in accordance with certain aspects of the present disclosure.

FIGS. 7A, 7B, and 7C are exemplary illustrations of patterns generated in thermoplastic materials by directing an energy beam into the thermoplastic materials to form microcellular, in accordance with certain aspects of the present disclosure.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Bubbles can be induced in a thermoplastic material for creating a foam. For example, a high-pressure gas can be infused into to the thermoplastic material for use in inducing bubble nucleation. In some cases, a hot oil bath and/or a hot press can be applied to the thermoplastic material for generating bubbles in the thermoplastic material. Applying a hot oil bath and/or a hot press to a gas-infused thermoplastic material, however, may result in the entire thermoplastic material being foamed rather than a select region. In some cases, it may not be possible to control the morphological characteristics of the resulting foam when using a hot oil bath and/or hot press to generate the bubbles.

Certain aspects of the present disclosure can overcome the aforementioned problems by directing one or more energy beams into the thermoplastic material to generate microcellular bubbles. For example, a thermoplastic material can be placed in a pressure vessel and infused with a high-pressure gas. After being infused with the gas, the resulting gas-infused thermoplastic material can be removed from the pressure vessel. A user or a computing device can select a portion of the thermoplastic material to be foamed. An apparatus can transmit an energy beam onto the selected portion of the thermoplastic material to induce subsurface heating of the thermoplastic material. The subsurface heating can result in the formation of microcellular bubbles in the selected portion of the thermoplastic material. For example, the subsurface heating can raise the temperature of the thermoplastic material to a temperature near the glass transition temperature of the polymer to cause a large number of bubbles nucleate, thereby forming the microcellular bubbles. In some examples, an instability caused by a sudden reduction in gas solubility as the gas-infused thermoplastic material is heated can be a driving force to nucleate bubbles. Examples of thermoplastic materials in which microcellular bubbles can be selectively formed as described herein include amorphous and semi-crystalline thermoplastics such as Polyvinyl Chloride (PVC), Polycarbonates (PC), Acrylonitrile Butadiene Styrene (ABS), Polyethylene Terephthalate (PET), Polyethylene terephthalate glycol (PETG), Crystalline Polyethylene Terephthalate (CPET), or any other suitable thermoplastic material.

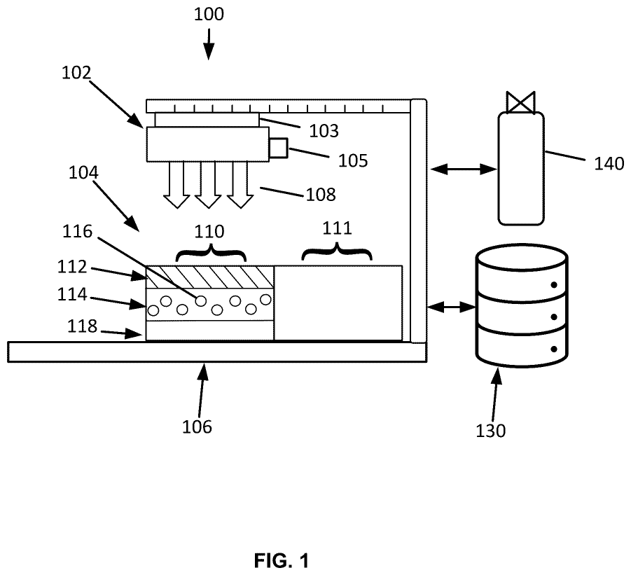

Turning now to the figures, FIG. 1 is a schematic of an apparatus 100 that is operable for directing an energy beam 108 into a gas-infused thermoplastic member 104 to form microcellular bubbles 116 according to certain aspects of the present disclosure. The apparatus can include a support 106 for holding the gas-infused thermoplastic member 104. The gas-infused thermoplastic member 104 can include amorphous and semi-crystalline thermoplastics such as PVC, PC, ABS, PET, PETG, and CPET, or any other suitable thermoplastic material. In some examples, the gas-infused thermoplastic member 104 can be a thermoplastic sheet with a thickness in a range from 0.5 mm to 2 mm. The apparatus 100 can include an energy beam source 102 that generates the energy beam 108. The energy beam source 102 transmits the energy beam 108 into the gas-infused thermoplastic member 104. In some examples, the energy beam 108 includes electromagnetic radiation. For example, the energy beam source 102 can include one or more laser diodes that emit one or more coherent laser beams. The electromagnetic radiation can have a wavelength between 9.4 and 10.6 micrometers. In some examples, the electromagnetic radiation can be emitted in pulses. In some examples, the energy beam source 102 includes one or more heated filaments that emit one or more electron beams. In some examples, the energy beam source 102 includes one or more ultrasonic transducers that emit one or more ultrasonic acoustic beams. In some examples, the energy beam 108 can have a converging cross-section where the energy beam 108 enters the gas-infused thermoplastic member 102. The converging cross-section can be configured to compensate for attenuation of the energy beam 108 during transmission of the energy beam 108 within the gas-infused thermoplastic member 104.

The apparatus 100 includes a gas infusion assembly 140. In some examples, the gas infusion assembly 140 includes a pressure vessel that can be pressurized with a gas. The gas infusion assembly 140 is operable to infuse a gas into the thermoplastic member to form the gas-infused thermoplastic member 104. In some examples, the gas can include carbon dioxide. In other examples, the gas can include nitrogen. The gas-infused thermoplastic member 104 is internally heated by the energy beam 108 to form the microcellular bubbles 116. In some examples, the gas infusion assembly 140 is controlled by a control unit 130. The control unit 130 can be used to adjust parameters associated with the gas infusion assembly 140 prior to or while infusing the thermoplastic member with the gas to form the gas-infused thermoplastic member 104. In some examples, the gas infusion assembly 140 can apply a pressure of equal to or greater than 5 MPa to infuse the gas into the thermoplastic member.

The apparatus 100 includes a scanning assembly 103 that is coupled with the energy beam source 102 and/or the support 106. The scanning assembly 103 can be operated to produce controlled relative movement between the support 106 and the energy beam source 102 in order to scan the energy beam 108 over the selected portion of the gas-infused thermoplastic member 104. For example, the scanning assembly 103 can include a motor that can translate the energy beam source 102 across an XY plane that is parallel to the surface of the gas-infused thermoplastic member 104. Additionally or alternatively, the scanning assembly 103 can hold the energy beam source 102 stationary and can translate the gas-infused thermoplastic member 104 with respect to the energy beam source 102. In some examples, the scanning assembly 103 can include or be coupled to a focusing mechanism 105. The focusing mechanism 105 can be operable to focus the energy beam 108 prior to transmitting the energy beam 108 onto the gas-infused thermoplastic member 104. For example, the energy beam 108 may be focused by the focusing mechanism 105 to a subsurface focal point within the gas-infused thermoplastic member 104. In some examples, the subsurface focal point can be scanned throughout a three-dimensional volume of the gas-infused thermoplastic member 104.

In some examples, an operator of the apparatus 100 or the control unit 130 can select a selected portion 110 of the gas-infused thermoplastic member 104 that is to be foamed. In many embodiments, the energy beam 108 is not transmitted onto an unselected portion 111 of the gas-infused thermoplastic member 104. The energy beam 108 induces subsurface heating in the selected portion 110 of the gas-infused thermoplastic member 104 to form the microcellular bubbles 116 in the selected portion 110. The subsurface heating can generate a foamed portion 114 within the selected portion 110 of the gas-infused thermoplastic member 104 that includes the microcellular bubbles 116. The energy beam 108 can be configured and directed to avoid inducing any substantial subsurface heating or bubble formation in the unselected portion 118 of the gas-infused thermoplastic member 104. In some examples, transmitting the energy beam 108 onto the selected portion 110 of the gas-infused thermoplastic member 104 causes a melted portion 112 to form above the foamed portion 114 of the gas-infused thermoplastic member 104. The thickness of the melted portion may be directly proportional to the power of the energy beam 108. The thickness of the melted portion 112 may be independent of the scanning speed of the scanning assembly 103 and the infusion pressure used to infuse the gas into the thermoplastic member. A wide range of microcellular bubble sizes can be obtained through manipulating the scanning speed and power parameters of the energy beam source 102. The microcellular bubbles 108 can be formed to extend throughout a range of depths from a surface of the gas-infused thermoplastic member 104 onto which the energy beam 108 is incident. The range of depths through which the microcellular bubbles extend can range from 0.1 mm to 0.6 mm.

The microcellular bubbles 116 can be morphologically tunable. That is, parameters associated with the apparatus 100 can determine the density of the microcellular bubbles 116 and the diameters of the microcellular bubbles 116. In some examples, the microcellular bubbles 116 can cause the foamed portion 114 of the gas-infused thermoplastic member 110 to exhibit electrical and/or mechanical properties that differ from the properties of the un-foamed portion 118 of the gas-infused thermoplastic member 104. For example, the foamed portion 114 may have decreased electrical conductivity and decreased thermal conductivity relative to the un-foamed portion 118. In some examples, the microcellular bubbles 116 in the foamed portion 114 may decease a bending strength of the foamed portion 114, thereby configuring the foamed portion 114 as a live hinge for use in forming the gas-infused thermoplastic member 104.

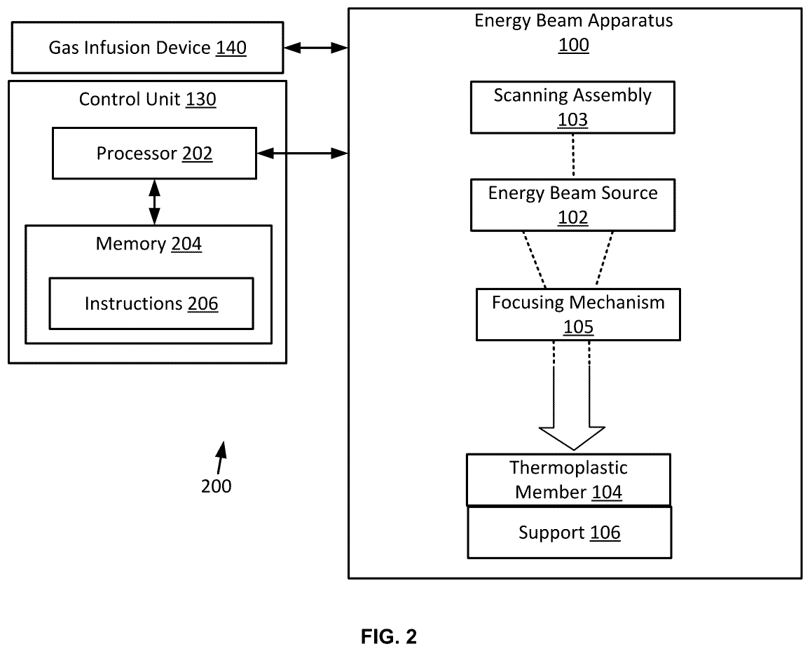

FIG. 2 is a block diagram of a system 200 for forming microcellular bubbles 116 in a thermoplastic member, in accordance with embodiments. The system 200 includes the apparatus 100, which as described herein is operable for directing the energy beam 108 into the gas-infused thermoplastic member 104 to form the microcellular bubbles 116 within the gas-infused thermoplastic member 104. The apparatus 100 is operatively coupled to the control unit 130. The control unit 130 includes a processor 202 and a memory 204. The processor 202 can include one processor or multiple processors. Examples of the processor 202 include a Field-Programmable Gate Array (FPGA), an application-specific integrated circuit (ASIC), and a microprocessor. The processor 202 can execute instructions 206 stored in the memory 204 to cause the processor to control the apparatus 100 to form the microcellular bubbles 116 within the gas-infused thermoplastic member 106. In some examples, the instructions 206 can include processor-specific instructions generated by a compiler or an interpreter from code written in any suitable computer-programming language, such as C, C++, C #, and Java.

The memory 204 includes one memory device or multiple memory devices. The memory 204 can be volatile or non-volatile, in that the memory 204 can retain stored information when powered off. Examples of the memory 204 include electrically erasable and programmable read-only memory (EEPROM), flash memory, or any other type of non-volatile memory. At least a portion of the memory device includes a non-transitory computer-readable medium. A computer-readable medium can include electronic, optical, magnetic, or other storage devices capable of providing the processor 202 with the instructions 206 or other program code. Non-limiting examples of a computer-readable medium include magnetic disks, memory chips, ROM, random-access memory (RAM), an ASIC, a configured processor, optical storage, or any other medium from which a computer processor can read the instructions 206.

The processor 202 can be communicatively coupled to the energy beam apparatus 100 and/or any component of the energy beam apparatus 100. For example, the processor 202 can be communicatively coupled to the scanning assembly 103 to control operation of the scanning assembly 103. In some examples, the processor 202 can be communicatively coupled with the focusing mechanism 105 to control operation of the focusing mechanism 105. Additionally, the processor 202 can be communicatively coupled to the energy beam source 102 to control operation of the energy beam source. For example, in some embodiments, the processor 202 can adjust the power of the energy beam 108 and/or any other suitable operational parameter of the energy beam source 102.

The instructions 206 can be executable by the processor 202 to cause the processor 202 to control operation of the energy beam source 102. In some examples, the instructions 206 can be executable by the processor 202 to cause the processor 202 to control operation of the focusing mechanism 105 to focus the energy beam 108 with respect to the gas-infused thermoplastic member 104, such as to cause the energy beam to have a converging cross-section during propagation within the gas-infused thermoplastic member 104, or to cause the energy beam to be focused to a focal point within the gas-infused thermoplastic member 104 that is scanned within the selected portion 110. The instructions 206 can also be executed by the processor 202 to cause the processor 202 to control operation of the scanning assembly 103 to translate the energy beam source 102 and the focusing mechanism 105 relative to the support 106 and the gas-infused thermoplastic member 104 mounted to the support 106.

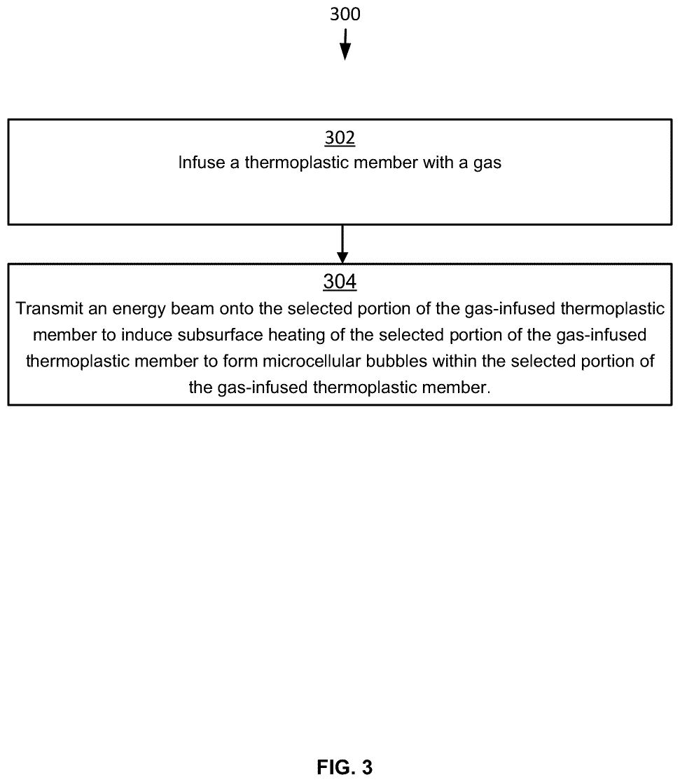

FIG. 3 is a flowchart of a process 300 of forming microcellular bubbles 116 within a thermoplastic member, in accordance with embodiments. The process 300 can be practiced with any suitable apparatus and/or system for forming microcellular bubbles within a thermoplastic member, such as those described herein.

In act 302, a gas is infused into a thermoplastic member. In some embodiments, the gas consists of or includes carbon dioxide. The gas can alternately consist of or include any other suitable gas that can be infused into a thermoplastic member to be subsequently heated to nucleate microcellular bubbles in the thermoplastic member. The thermoplastic member can be placed within a gas infusion apparatus that can infuse the gas into the thermoplastic member under a suitable level of applied pressure.

In act 304, an energy beam is transmitted to be incident on a selected portion of the thermoplastic member. Transmitting the energy beam onto the selected portion of the thermoplastic member induces subsurface heating of the selected portion of the thermoplastic member that forms microcellular bubbles within the selected portion of the thermoplastic member.

In some examples, a laser engraver can be used to scan the laser beam emitted by the laser engraver onto the selected portion of the thermoplastic member to form the microcellular bubbles within the selected portion of the thermoplastic member. Certain parameters, such as the saturation pressure, scanning speed, and power of the laser beam emitted by the laser engraver can be adjusted to tune morphological parameters of the foam. Such morphological parameters can include bubble size and distribution within the thermoplastic member. Polycarbonate thermoplastic members can be cut using a shear and their dimensions measured using digital calipers. Next, they can be saturated with carbon dioxide gas at 5 MPa using a pressure vessel. The time taken to saturate the thermoplastic members, based on a nominal thickness of 1.5 mm, can be calculated to be approximately 65 hours. After removal from the pressure vessel, thermoplastic members can be weighed using a precision mass balance prior to foaming, to obtain the CO₂ gas concentration.

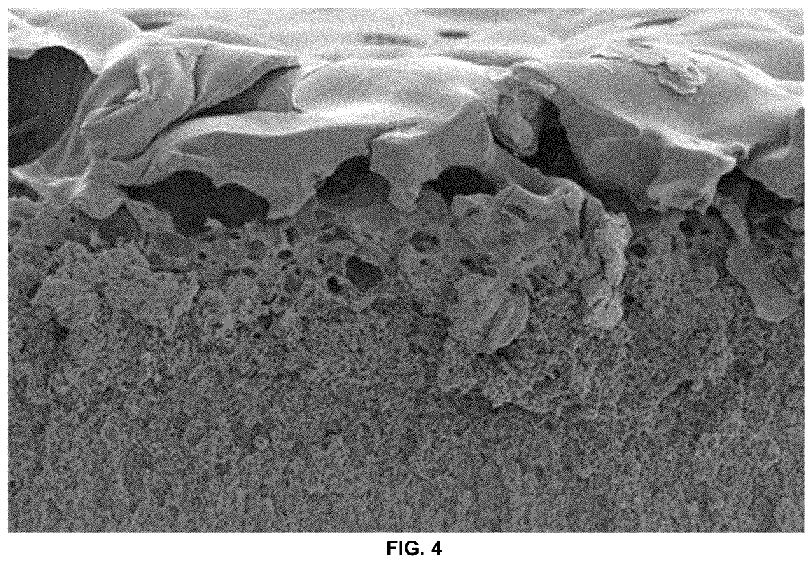

FIG. 4 is an illustration of an exemplary thermoplastic member having microcellular bubbles according to certain aspects of the present disclosure. As shown in FIG. 4, the top surface of the foam shows signs of being melted by the laser before resolidifying. The region underneath the melted and resolidified top layer is shown as being foamed and can include a microstructural distribution of bubbles.

The thermoplastic member can include a porous surface morphology. The surface which may appear to be a solid, unbroken patch at the macroscopic scale, can have numerous holes when magnified under the microscope. The holes can be caused due to escaping gas as the surface is being melted by the transmitted energy beam. In some examples, the holes may be connected to the underlying cell microstructure. In some examples, transmitting the energy beam into the thermoplastic member can result in open celled structures. Four parameters can be analyzed in thermoplastic member micrographs at 1, 3 and 5 MPa: melted surface thickness, a depth of the foamed region, an average cell size within the uniform cell distribution, and a cell size range (from under the melted surface layer until the ‘transition’ region, where the microstructure may transition to solid polycarbonate).

Using an energy-beam-based processing technique can melt the surface whereas the existing techniques can produce a solid, un-foamed skin. Hence, it may be desirable to measure the melted surface thickness and study its relation (if any) to the processing parameters as it represents an effective ‘skin’ for energy beam induced foaming. The remaining parameters like foam depth, average cell size, and cell size range help quantify the primary region of focus, which can be the microcellular foam generated. An average of 10 readings for the melted surface thickness and foam depth can be taken along the cross section of the thermoplastic member.

In some examples, the melted layer can become progressively smoother to the touch as the dots-per-inch (DPI) setting of the energy beam is decreased. That is, a relationship can be established in the microcellular range, of DPI vs. melted layer thickness, that can correspond to the surface roughness. The surface roughness can be measured using a profilometer. Further possible relationships can be explored between the DPI setting and how or if this influences the average bubble size, as well as the energy (keeping speed and power constant) and subsequently the surface temperature of the thermoplastic member. In some examples, the method can involve using an FEM based approach with a governing equation (possibly based on laser welding analytical expressions) to determine a predicted temperature distribution along the surface. The model can be validated with real temperature data measured for various settings of speed and power, by using temperature measurement devices, like a thermocouple or a thermal camera.

In some examples, increased energy beam power may decrease the size of the microcellular bubbles. In some examples, the melted surface layer (which can be directly dependent on the power) can inhibit the heat from the energy beam from spreading into the underlying microcellular structure. As this melted surface layer increases in thickness, lesser energy can be transferred to the microstructure, which can lead to decreased growth and/or nucleation from individual bubbles.

FIG. 5A is an illustration of a laser engraver that can direct energy beams into a thermoplastic material to form microcellular bubbles according to certain aspects of the present disclosure.

FIG. 5B is an exemplary graphical user interface for controlling a laser engraver according to certain aspects of the present disclosure. For the laser engraving process, the focal point can be manually set using a focus tool attachment (41.46 mm height) to the surface of each individual thermoplastic member. Corel Draw 2020 can be used to enter the speed and power parameters under ‘Raster’, with a center engraving setting chosen for all thermoplastic members exposed to the laser beam. Raster can be used for jobs involving engraving, whereas the Vector setting can be used to cut shapes out of materials and therefore may not be applicable to the invention.

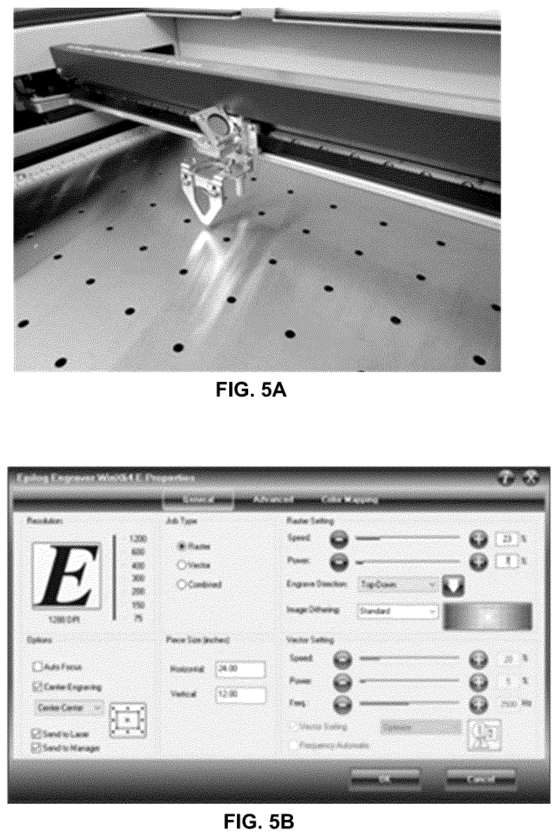

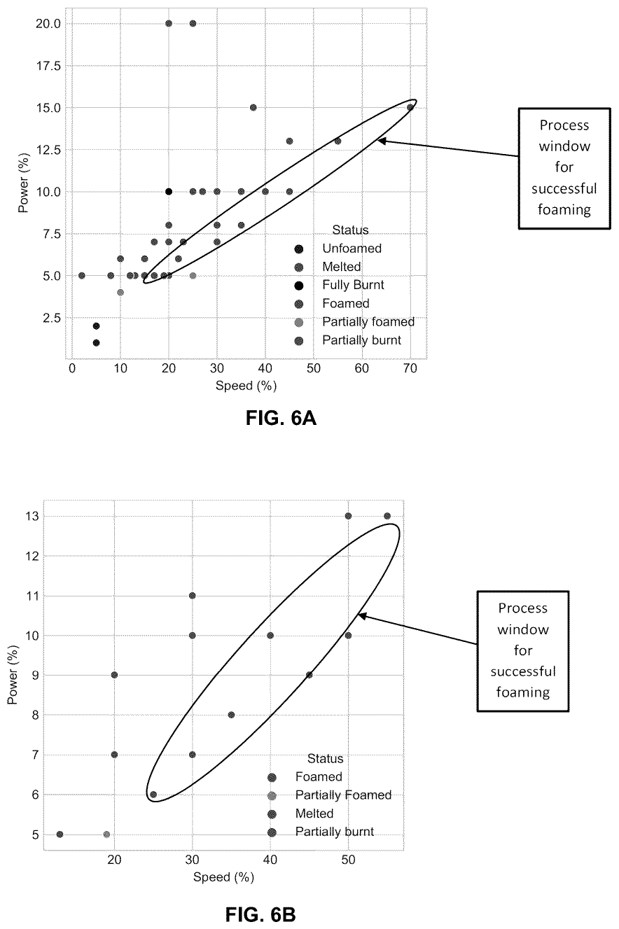

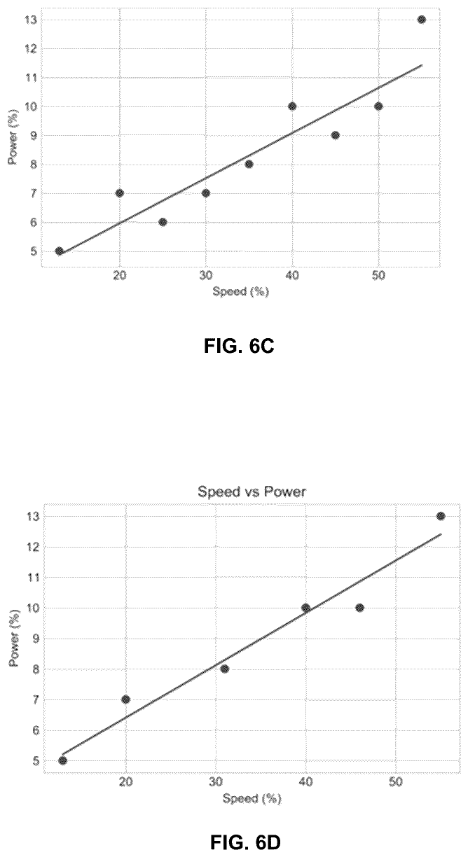

FIG. 6A is an exemplary graph of a process window for directing an energy beam into a thermoplastic material to form microcellular bubbles according to certain aspects of the present disclosure. In some examples, polycarbonate thermoplastic members can be saturated with CO2 at 1, 3 and 5 MPa pressures, and subsequently foamed via an energy beam source at arbitrary speed and power settings. A range of settings can be tested on thermoplastic members, and the results can be categorized by a simple visual indication of the appearance of the thermoplastic member, i.e., whether it had successfully ‘foamed’, burnt/completely melted, or partially foamed. A graph of energy beam power vs. scanning speed can be plotted on Python, incorporating the distribution of speed and power data points, as shown in FIG. 6A. A clear process window can be observed between the speed and power settings at 5 MPa for the foamed thermoplastic members. Increasing the power too much (above the process window region) can cause the thermoplastic members to melt and get burned, whereas increasing the speed too much (under the process window region) can result in an incomplete foaming pattern. Similar results at lower saturation pressures can be shown in FIG. 6B and FIG. 6C.

In some examples, a user can observe a conformance in gradient values, which can indicate that the energy per unit length required to induce foaming may depend on the saturation pressure of the thermoplastic members. In some examples, the processing window may narrow as the pressure decreases. This can occur due to available CO2 gas concentration decreasing from approximately 9% to 6% to 2.5%, referring to the tabular data for CO2 gas concentration prior to foaming, at various saturation pressures. The foamed thermoplastic members at various pressures of 1, 3 and 5 MPa can be fractured in liquid nitrogen and studied under a Scanning Electron Microscope (SEM).

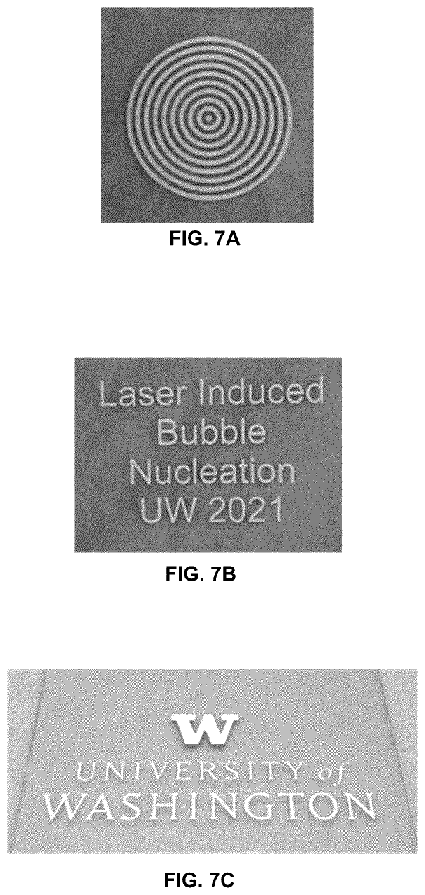

FIG. 7A-C are exemplary illustrations of patterns generated in thermoplastic materials by transmitting an energy beam into the thermoplastic materials to form microcellular bubbles according to certain aspects of the present disclosure.

Experiments can be carried out to determine and adjust speed and power settings of the laser engraver. In some examples, the laser engraver can generate a white, opaque foamed patch on the polycarbonate thermoplastic members. The speed and power settings can be expressed as percentage values of the maximum setting. The maximum speed (100%) may be roughly 82 inches/second and maximum power (100%) may be roughly 40 W. The DPI (dots per inch) setting for thermoplastic members can be kept fixed at its maximum value of 1200. At saturation pressures of 5, 3 and 1 MPa, several exploratory experiments can be conducted to determine if the process of engraving a foam using a laser beam can be feasible or possible, and to ascertain if any trend or process window can be obtained for this novel technique. The preliminary results are discussed after this section. A wide spectrum of foams can be obtained from varying the speed and power. A bright white foam can be obtained, indicating a perfectly foamed thermoplastic member, and can be a visual indicator of a successful foam. Other types of foams obtained can be either characterized by a melted or burnt appearance, i.e. yellow/caramel or occasionally black patches on the thermoplastic member area engraved, in an extreme case the surface may be gouged/peeled open by the laser. A striped pattern can indicate signs of transparency or incomplete foaming. Burnt thermoplastic members can ‘fade out’ near the top edge of the engraved portion which can indicate the burnt deposits of thermoplastic particles on the surrounding area of the thermoplastic member.

Altering the saturation pressure may not have an immediately discernible effect on the type of foams produced, but the range of settings inducing successful foams can vary. An image of the foamed region can be scaled, and then a filter can be applied to it to set the range of cell sizes to be resolved by the software. To this filtered image, an arbitrary threshold can be set by adjusting a bar (using trial and error) to shade the bubble regions whose areas need to be measured. This generates an overlay. The area distribution can be analyzed for the overlay and the values for individual cells can be exported to an Excel file.

The method described in the present disclosure can sometimes combine separate cell areas to be measured, or conversely treat additional artefacts from the SEM as cell areas to be measured. Additional image cleaning can result in a more accurate representation of the areas measured. Cleaning can include manually erasing artefacts from the processed image. To find the average cell size (diameter), the cell areas can be approximated as circular, although they may have irregular shapes. The individual cell diameters can be found using this approximation, before taking an average of all these diameter measurements to obtain a final average diameter. At 5 MPa saturation pressure and a fixed power of 5%, different speeds of the laser can be applied to 3 different polycarbonate thermoplastic members that had successfully foamed, and the effect on average cell size due to speed can be investigated.

The method of the present disclosure may result in a clear trend in the average cell size. The cell size can decrease with an increase in speed (other factors remaining constant). A lower energy can indicate that individual cells nucleate to a smaller extent. At a 3 MPa saturation pressure, two thermoplastic members can be chosen to study the effect on average cell size of varying the power delivered by the beam, while keeping the speed constant. Exemplary results are discussed below.

The speed and power settings of the laser beam inducing foaming in the thermoplastic member eventually influence or contribute to one important quantity that dictates whether the thermoplastic member successfully or partially foams, or gets burnt, and that is the energy delivered to the thermoplastic member. Therefore, it may be desirable to determine a value for the energy that is given to a thermoplastic member, from the input settings applied. Below is an example calculation based on known quantities for an exemplary thermoplastic:

$$Power ( in W ) = \frac{p}{100} * 40$$

$$Speed ( in m / s ) = \frac{v}{100} * 82 * 0.0254$$

Nominal thickness of 1.5 mm,

Sample Height=1.5*10⁻³ m
Taking a foamed area of 1.5 cm×0.5 cm,

Foam Area=0.015*0.005=7.5*10⁻⁵ m²

DPI=1200

From the DPI setting one can find the dots per cm:

Dot cm⁻¹=1200/2.54

The dots per cm² area can then be found as follows:

Dot cm⁻²=(Dot cm⁻¹)*(Dot cm⁻¹)=223200.45

The total number of dots in the foamed patch of 1.5 cm×0.5 cm:

Dot Total=Dot cm⁻²*Foam Area (in cm²)=˜167,400

Time taken per dot:

$$Dot Time ( in seconds ) = \frac{Foaming Time}{Dot Total} = \frac{{t}_{foam}}{Dot Total}$$

As the power is delivered per dot pulsed by the laser, one can find the energy delivered per dot:

Dot Energy (in J)=P*Dot Time

Total energy delivered to the thermoplastic member:

Total Energy (in J)=Dot Energy*Dot Total

Substituting values for the speed and power settings within the successful foaming process window (55% speed, 13% power and a foaming time of 23 seconds), yielded the following results:
Time taken per dot: Dot Time=1.374*10⁻⁴ s
Energy delivered per dot: Dot Energy=7.145*10⁻⁴ J
Total energy delivered to the thermoplastic member: Total Energy=119.6 J

The energy delivered per dot and total energy delivered to the thermoplastic member can be used in two separate approaches in the next two sections to estimate a surface temperature. Finding the energy value can serve as an initial step to estimate a surface temperature reached by the thermoplastic member. Two approaches to estimate the surface temperature are discussed below.

In this approach the surface temperature can be calculated using the energy per dot.

Let T=surface temperature and T_{inf}=ambient temperature

The energy supplied per dot can cause a temperature increase in the thermoplastic member according to the following relation:

Dot Energy=m*Cp*(T−T_{inf})

Chosen values (PC properties taken from [15]):

$${T}_{inf} = 23 ° C . , {C}_{p} = 1250 J / ( kg \cdot K ) , ρ = 1200 kg / {m}^{3} ,$$

$$spot size ( diameter ) = 0.1016 mm$$

$$m = vo l . * ρ = \frac{π}{4} * {( 0.1016 * 1 {0}^{- 3} )}^{2} * 670.0206 * 1 {0}^{- 6} * 1200$$

Some assumptions that can be made using this model are:
Circular spot size of 0.004 inches can be considered, although the spot is elliptical with a major and minor diameter of 0.005 in and 0.003 in respectively.
A depth till the transition region can be considered when calculating the effective ‘dot volume’ foamed (see Fig). This can be then used to find the mass quantity m when estimating the temperature.
The temperature T being found is assumed to be the surface temperature, although the expression treats this as an overall, bulk temperature for the thermoplastic member.

Substituting the same values of speed, power and time as used in Section 4.1 (55% speed, 13% power and a foaming time of 23 seconds), the final predicted temperature may be equal to or about 110.69° C.

This solution can be lower than the expected range, as the top surface can be melted by the laser from the SEM micrographs studied previously. The melting temperature of polycarbonate can be in the approximate range of 220° C.-260° C. [14], so a temperature in this vicinity should be expected.

Another approach to estimating the surface temperature can involve using the total energy delivered to the thermoplastic member.

$$Energy input = \begin{matrix}Energy causing \\ temperature rise\end{matrix} + \begin{matrix}Energy losses due to conduction , \\ convection , and radiation\end{matrix} \qquad ( ii )$$

Chosen values (same as Model 1):
Ambient temperature=T_{inf}, Surface temperature=T
For energy causing temp rise: Cp=1250 J/(kgK), ρ=1200 kg/m³

Chosen parameters for conduction, convection, and radiation ([15]):

k=0.22 W/(m·K), h=0.21 W/(m²K), ε=0.94 and σ=5.670367*10⁻⁸ W·m⁻²K⁻⁴

Equation (2) can be written as:

Total Energy=m*Cp*(T−T_{inf})+t_{foam}*(k*A*(T−T_{inf})+h*A*(T−T_{inf})+ε*A*σ*(T4−T_{inf}⁴)) (iii)

Substituting 55% speed, 13% power and a foaming time of 23 seconds and using Python to solve the nonlinear equation (iii) for surface temperature T,
Final (predicted) surface temperature T=519.1° C.

Some assumptions made using this model:
To calculate the mass term in the energy causing temperature rise quantity (using volume*density), it is possible to calculate a foam volume by taking the product of the area foamed by the thermoplastic member height and not by the melt surface thickness+foamed depth (used in model 1), because a smaller value for the volume causes the temperature rise to be even greater. Assuming a conduction loss for the surface in contact with the laser bed, the total thermoplastic member thickness can be considered.
The temperature T being found is assumed to be the surface temperature, although the expression for ‘Energy causing temperature rise’ treats this as an overall, bulk temperature for the thermoplastic member.

The successful foam microstructure for various thermoplastic members can be investigated under the SEM, and the corresponding effect of varying the process parameters like speed, power, and saturation pressure on the micro scale features like melted (and resolidified) surface thickness, foam depth and average cell size can be analyzed. Some interesting results can be obtained, some intuitive, while others can be new inferences learned. A direct relation between speed and average cell size can be established, as well as a limiting relation between power and average cell size, on account of the melted surface thickness inhibiting the heat from the laser beam. It can be deduced that speed and power can be simplified into one intrinsic quantity that is energy, and an attempt can be made to estimate this energy delivered by the laser beam and the consequent temperature rise at the surface of the thermoplastic member.

The results can be refined by taking micrographs at the same magnifications and re computing an average cell size to ensure uniformity in raw data. The results can similarly be refined by choosing a region of cells at a fixed distance from the melted surface thickness, for different power settings, all other factors remaining constant.

Some examples may involve varying the thickness of thermoplastic members to be engraved, as this changes the CO2 concentration at equilibrium, and can therefore lead to different micrographs, i.e., potentially altered cell sizes and corresponding foam depth. Calculating the cell nucleation density achieved by this new method. This can be used to find a measure of the relative density of foamed structures that lasers have the capability of producing. This has promising applications in sustainable development, specifically for weight reduction and material conservation, in situations where material strength is not a critical factor.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method of forming microcellular bubbles within a selected portion of a thermoplastic member, the method comprising:
infusing the thermoplastic member with a gas to form a gas-infused thermoplastic member; and
transmitting an energy beam onto the selected portion of the gas-infused thermoplastic member to induce subsurface heating of the selected portion of the gas-infused thermoplastic member to form microcellular bubbles within the selected portion of the gas-infused thermoplastic member.

2. The method of claim 1, wherein:
infusing the thermoplastic member with the gas to form the gas-infused thermoplastic member comprises applying a pressure to the thermoplastic member that is equal to or greater than 5 MPa; and
the gas comprises carbon dioxide.

3. The method of claim 1, wherein the energy beam comprises electromagnetic radiation comprising wavelengths in a range from 9.4 to 10.6 micrometers.

4. The method of claim 3, wherein the energy beam comprises pulses.

5. The method of claim 1, wherein the energy beam comprises electromagnetic radiation.

6. The method of claim 1, wherein the microcellular bubbles comprise diameters in a range from 1 to 100 microns.

7. The method of claim 1, wherein:
the microcellular bubbles extend throughout a range of depths from an irradiated surface of the gas-infused thermoplastic member onto which the energy beam is transmitted; and
the range of depths is in a range from 0.1 mm to 0.6 mm.

8. The method of claim 1, wherein the energy beam has a converging cross-section to compensate for attenuation of the energy beam during penetration of the energy beam into the gas-infused thermoplastic member.

9. The method of claim 1, wherein the energy beam is focused to a subsurface focal point within the gas-infused thermoplastic member.

10. The method of claim 9, wherein the subsurface focal point is scanned within the gas-infused thermoplastic member throughout a three-dimensional subsurface volume of the gas-infused thermoplastic member.

11. The method of claim 1, wherein the thermoplastic member is formed from one or more of PC, PEI, TPU, PET, PVC, ABS, or any other suitable thermoplastic with a glass transition temperature above room temperature.

12. The method of claim 1, wherein the thermoplastic member is configured as a thermoplastic sheet with a thickness in a range from 0.5 mm to 2 mm.

13. The method of claim 12, wherein the microcellular bubbles in the selected portion of the gas-infused thermoplastic member reduce a bending strength of the selected portion to configure the selected portion as a live hinge for use in forming the gas-infused thermoplastic member.

14. The method of claim 1, wherein the selected portion of the gas-infused thermoplastic member is at least partially surrounded by an unselected portion of the gas-infused thermoplastic member onto which the energy beam is not transmitted.

15. A system for forming microcellular bubbles within a selected portion of a gas-infused thermoplastic member, the system comprising:
a support configured for holding a gas-infused thermoplastic member;
an energy beam source operable to transmit an energy beam; and
a scanning assembly coupled with the support and/or the energy beam source, wherein the scanning assembly is operable to produce controlled relative movement between the support and the energy beam source to scan the energy beam onto and over the selected portion of the gas-infused thermoplastic member to form microcellular bubbles within the selected portion.

16. The system of claim 15, wherein the energy beam source comprises at least one of: one or more laser diodes that are operable to emit one or more coherent laser beams, one or more filaments that are operable to emit one or more electron beams, or one or more ultrasonic transducers that are operable to emit one or more ultrasonic acoustic beams.

17. The system of claim 15, wherein the scanning assembly includes a focusing mechanism that is operable to focus the energy beam to a subsurface focal point within the gas-infused thermoplastic member.

18. The system of claim 15, further comprises a control unit comprising a processor and a non-transitory computer-readable memory, wherein the processor is configured to control operation of the scanning assembly and/or the energy beam source.

19. The system of claim 15, wherein the selected portion of the gas-infused thermoplastic member is at least partially surrounded by an unselected portion of the gas-infused thermoplastic member onto which the energy beam is not transmitted.

20. The system of claim 15, further comprising a gas infusion assembly to infuse a gas into the thermoplastic member prior to scanning of the energy beam onto and over the selected portion of the gas-infused thermoplastic member to form the microcellular bubbles.
